(19) United States
(12) Patent Application Publication
(10) Pub. No.: US 2007/0065270 A1
(43) Pub. Date: Mar. 22, 2007

(54) Stacking device

(76) Inventors: Dietmar Schmetzer, Gschlachtenbretzingen (DE); Heribert Orth, Ilshofen (DE); Klaus Griessmayr, Rosengarten (DE)

Correspondence Address: Michael J McGovern;Quarles & Brady, 411 E. Wisconsin Ave., Milwaukee, WI, 53202-4497, US

(21) Appl. No.: 10/570,862

(22) PCT Filed: Aug. 27, 2004
(86) PCT No.: PCT/EP04/09566

§ 371 Date: Nov. 20, 2006

(30) Foreign Application Priority Data
Sep. 8, 2003 (DE) 103 41 992.6

(51) Int. Cl. B65G 57/11

(52) U.S. Cl. 414/794.4

(57) ABSTRACT

A stacker for stacking products that are singly, consecutively conveyed to it contains numerous compartments, into each of which a single product is inserted, that are moved around a closed circuit. A stack of products is then ejected from several adjacent compartments. The compartment that is currently being loaded is opened such that the pair of walls forming the compartment are spread apart, in particular, are pivoted apart, which will alter the compartment that was loaded immediately prior to it such that the product contained therein will be straightened and compacted.

The invention relates to a stacker for stacking products that are singly, consecutively conveyed to it.

Need for such stackers arises, for example, during the packaging of such products. The products involved are consecutively offloaded from items of manufacturing equipment. Their packagings are supposed to contain several such products, which therefore must have been previously consolidated into stacks. The products involved are frequently flat items, i.e., items that have one dimension that is much smaller than their other dimensions.

Stackers that have individual compartments, each of which has, for example, a pair of walls, attached to a circulating belt or chain for the purpose of forming such stacks are known. Their walls are attached to chain links or the belt. Products are fed in at a location where the compartment walls spread apart due to the belt or chain running over idler rollers, pulleys, or sprockets. The belt or chain are frequently guided over a triangular or rectangular arrangement of idler rollers, pulleys, or sprockets for that purpose, where one of the rollers, pulleys, or sprockets is frequently motor-driven, while the others are free-running and driven by the belt or chain.

In order to eject a stack that has been formed, a section, within which the belt or chain appears to be stationary, is formed while the belt or chain continues to be driven, which may, for example, be accomplished by laterally translating a pair of idler rollers, pulleys, or sprockets as a unit.

In the case of a stacker of that type (cf. U.S. Pat. No. 4,399,905), the products involved are inserted into the compartments while they are opening as they pass the location where the drive is situated.

In the case of another stacker of that type (cf. U.S. Pat. No. 6,021,886), the belt follows a pentagonal path and is supplied with products at one corner thereof.

However, employing belts that are guided over triangular or rectangular paths means that the stacker will occupy a substantial amount of space, as will also be the case if the belt is guided over just a single pair of rollers, in which case, supplying the belt with products will have to take place along its longitudinal axis.

The invention is based on the problem of creating a general-purpose stacker for stacking individual products.

In order to solve that problem, the invention proposes a stacker having those features stated under claim 1. Elaborations on the invention are covered by the subclaims.

The invention thus contains a circulating conveyor, for example, a belt, chain, or similar, that is set in motion by a drive. The conveyor's motion transports numerous compartments around a closed circuit. An opening station that opens and closes the compartments is situated at a location where the products are fed in. “Closing” is defined here as restoring compartments to the status they have throughout the rest of the circuit. Stacks of products may then be offloaded at a location other than that where the opening station is situated.

Stacks of products might also be ejected by translating the ejection mechanism in synchronism with the circulating conveyor along some section thereof, in which case it will be unnecessary to bring the circulating conveyor to a seeming halt.

The circulating conveyor employed may be any type of conveyor that is capable of conveying the compartments around a closed circuit. The compartments might, for example, also be guided on a rail.

In particular, the drive that acts on the conveyor might drive the conveyor directly. The invention proposes, under an elaboration thereon, providing at least a pair of independently operating drives that act on the conveyor, which will allow bringing the circulating conveyor to a seeming halt at the location where the offloading station is situated. That seemingly stationary status may be brought about by, for example, laterally translating idler rollers, pulleys, or sprockets, about which the conveyor is guided.

In elaborating on the invention, it may be provided that each compartment is formed by, or has, a pair of sidewalls that are spread apart, relative to their normal positions relative to one another, at the opening station and subsequently brought back together after at least one product has been inserted between them. That motion may preferably be controlled by, for example, forces exerted by the guide, along which the compartments, or their walls, are slid.

Having both compartment walls move during the opening and closing of compartments has been found to be particularly beneficial. Compartments approaching the loading station will be empty. However, compartments that have just left the loading station will have been loaded during the preceding cycle. If both of their walls are then brought together, that will cause products that have just been inserted between them to be slightly compacted, since their walls will exert forces on them. That compacting may be of benefit in the case of the types of products to be processed that are primarily involved here, which will particularly be the case if products are propelled into compartments at high speeds, which will compact them somewhat. The opening of compartments prior to the next product insertion will straighten and flatten products that were inserted therein during the preceding cycle.

The motions of the compartment walls may be of various natures, for example, a linear translation of at least one compartment wall. At least one compartment wall might also be rotated.

In elaborating on the invention, compartment walls may be attached to a guide, along which they are slid. However, it will be particularly sensible if compartment walls are attached to the conveyor, and such is covered by the invention. In particular, that approach will be sensible if the circulating conveyor is a belt or a chain. In the latter case, compartment walls could be fastened directly to the chain's links.

According to the invention, it may be provided that the guide for compartment walls and/or conveyor may have a bend at the location of the opening station, which will cause the compartment walls to pivot open and closed.

In particular, it may be provided that, at the location of the opening station, the conveyor is guided over three rollers, pulleys, or sprockets that will cause that opening motion, where it will be particularly important that the routing of the conveyor ahead of, and following, the opening station may be symmetric in order that the rollers, pulleys, or sprockets involved will all have the same diameter and the two free runs will, nevertheless, be parallel to one another over their full lengths when the conveyor is guided over a total of just two idler rollers, pulleys, or sprockets.

Namely, the invention proposes that at least two idler rollers, pulleys, or sprockets that form a pair of, preferably parallel, free runs be provided for the conveyor. Drive may then be via a free run, instead of via the idler rollers, pulleys, or sprockets.

According to the invention, it may be provided that the conveyor has several sections, each of which contains parallel free runs. In particular, the individual sections may be arranged such that they are angularly offset with respect to one another, for example, be arranged at right angles to one another.

Drive via a free run, instead of via the idler rollers, pulleys, or sprockets, allows incorporating more than a single loading station, as is foreseen by the invention.

More than a single offloading station may also be provided.

Further features, details, and benefits of the invention will be evident from the claims and the abstract, whose respective wordings are herewith made integral parts of this description by way of reference thereto, from the following description of a preferred embodiment of the invention, and from the figures, which depict:

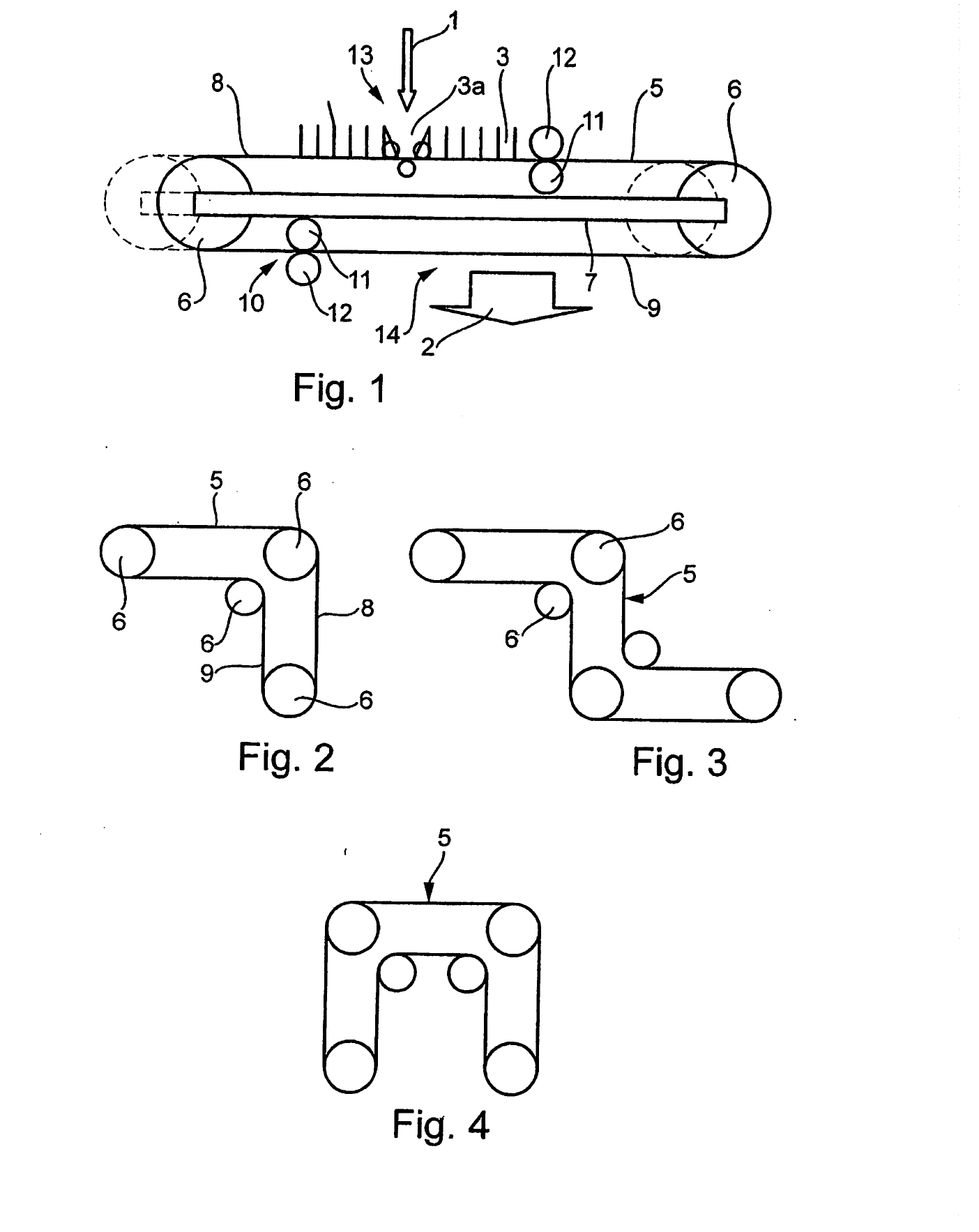

FIG. 1 a schematized top view of a stacker according to the invention;

FIG. 2 an even more schematized representation of a stacker having two sections;

FIG. 3 a schematized representation of a stacker having three sections that are angularly offset with respect to one another;

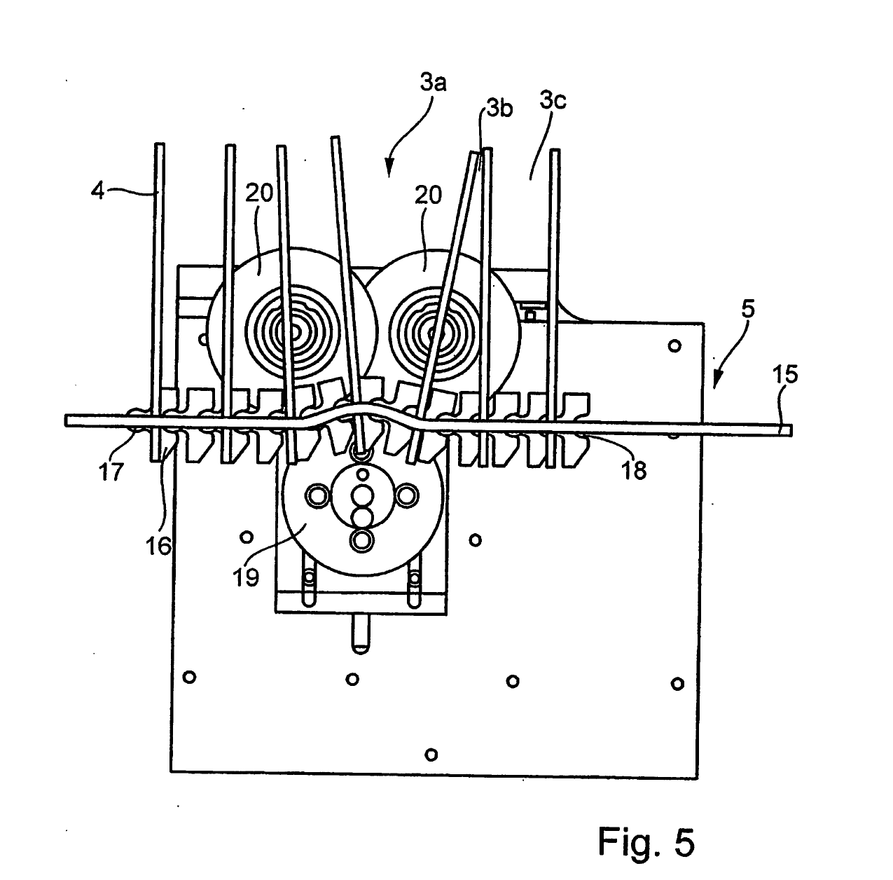

FIG. 4 a representation of an arrangement having four sections that are angularly offset with respect to one another;

FIG. 5 a more detailed representation of the arrangement of the circulating conveyor at the location of the loading station.

FIG. 1 depicts a general view to be employed in explaining the operation of a stacker according to the invention. The stacker is used for reorienting individual products consecutively conveyed to it in the direction of the arrow 1 such that several products lying next to one another, forming a stack, may be offloaded in the direction of the arrow 2. The widths of the arrows 1, 2 are intended to indicate that narrow products may be assembled into broad stacks.

The stacker contains numerous compartments 3 formed by walls 4 that are conveyed around a closed circuit, where each wall 4 serves as a wall for compartments 3 located ahead of it and behind it. The compartments 3 are conveyed by a circulating conveyor 5, for example, a belt. That belt is guided over a pair of idler rollers 6 that are mounted on a rail 7. The idler rollers 6 have the same diameter. A spring, or other device, may be provided in order to tension the circulating conveyor 5. That spring, or other device, spreads the pair of idler rollers 6 apart. The rail is mounted such that it may be translated along its longitudinal axis.

The belt forming the conveyor 5 forms a pair of free runs, namely, an upper free run 8 and a lower free run 9, as shown in FIG. 1. These lengthy free runs 8, 9 are parallel to one another. A drive 10 having a driven roller 11 and a free-running roller 12 on the other end of the belt is provided for each free run 8, 9. The drives are independent of one another, but controlled by a common mechanical and/or electrical controller.

The belt will run over the idler rollers 6 without the latter changing their respective locations when both drives 10 drive the circulating conveyor 5 at the same rate. The rates at which the rollers rotate at the loading point, which is indicated by the arrow 1, and at the offloading point, which is indicated by the arrow 2, are the same.

However, if the drive 10 on the lower free run 9 is halted while the drive 10 on the upper free run 8 continues to run, the free run 9 will appear to be stationary while the free run 8 continues to move, which will shift the pair of idler rollers 6 and their rail 7 to the right. If the rail 7 were to fail to move, the stacker would cease to function. The length of time during which those conditions may occur is, of course, limited. The drive 10 will then have to run faster than before if the original locations of the idler rollers are to be restored.

This option of briefly running the pair of free runs 8, 9 at differing rates is used for forming stacks. A loading station is arranged at the location of the arrow 1. At the loading station, the free run 8 will run at a constant rate as long as products are being fed in, since products will be fed in at a constant rate.

However, the associated section 9 of the circulating conveyor will be seemingly halted by halting the drive 10 in order that the stack may be simultaneously ejected in order to allow simultaneous offloading of a stack of products lying next to one another. Ejection may then be effected by a mechanism configured such that it is stationary with respect to the conveyor's direction of travel.

Of course, ejecting the stack using a mechanism that moves along with the conveyor 5 would also be feasible. In that case, a single drive for the stacker would be sufficient. However, the design of the ejection mechanism would then be complicated.

The compartments 3 are opened at the location where products are loaded onto the conveyor in the direction of the arrow 1 (cf. the compartment 3a). The loading station 13 is arranged at that location. An offloading station 14 is installed on the opposite side of the stacker, that is, approximately at the center of the free run 9.

Furthermore, since, in the case of the stacker whose operation has been briefly outlined, drive is via a free run, rather than via the idler rollers, the stacker may be compactly designed, since the pair of free runs may have several sections. That option is depicted in FIG. 2, where there are a total of four idler rollers 6, one of which engages the outer surface of the circulating conveyor 5. In this case, a pair of sections running at right angles to one another, within which the pair of free runs 8, 9 are parallel to one another, are formed.

FIG. 3 depicts an arrangement where the circulating conveyor 5 has three sections that are angularly offset with respect to one another and its pair of free runs are parallel to one another. Such an arrangement might be utilized for employing several ejection stations.

FIG. 4 depicts another option where the three sections of the circulating conveyor 5 are arranged in the form of a “U.”

As has been shown and described in conjunction with FIG. 1, the respective compartment 3a, into which the product is inserted, will be opened, which shall be discussed again, but in greater detail, in conjunction with FIG. 5. FIG. 5 depicts a more precise arrangement, where this representation should also be interpreted as being schematic only. In this case, the circulating conveyor 5 depicted is in the form of a belt 15. Discrete holders 16, each of which supports a compartment wall 4, are rigidly attached to the belt 15. The compartment walls 4 are thus orthogonal to the belt 15 at those locations where they are attached thereto. A single holder 16 that increases the spacing between adjacent compartment walls 4 is situated between each pair of adjacent compartment walls 4. The holders 16 are configured such that they may be interlocked with one another. That side of the holders 16 that faces in the direction of travel of the belt 15 has a protrusion 17 that engages an associated recess 18 on their opposite side, which will allow discontinuously altering the widths of compartments, i.e., the separation between adjacent compartment walls 4.

An idler roller 19 whose perimeter is configured such it deflects the belt 15 toward the loading station, that is, the outer surface of the circulating conveyor 5 to bulge outward, is present at the same location where the compartments are to be opened. However, since the belt 15 is flexible, a pair of idler rollers 20 that provide that the belt will follow the perimeter of the idler roller 19 is situated on the opposite side of the belt. These single idler rollers may be arranged at differing heights in order that they will not interfere with one another. These three idler rollers provide that the belt 15 will be deflected at the location where they are situated only, and will remain flat and follow a single, common, straight line both ahead of, and following, the idler station, which will provide that the free runs 8, 9 are parallel to one another and allow the idler rollers 6 that tension the belt 15 to have the same diameter.

The operation of the station that opens the compartments proceeds as follows: Assume that the belt 15 travels from left to right. Each compartment that has passed through the opening station, and thus through the loading station as well, will contain one or two products. Those compartments that have not yet reached the opening station will be empty. Compartment 3a is thus empty in FIG. 5, while compartments 3b and 3c have been loaded. Opening compartment 3a will reduce the width of compartment 3b, which will compact the product contained therein along a direction coinciding with the direction of travel. Since the products involved may be compactable, the opening of compartments that takes place at the opening station may be used to straighten products that have just been inserted therein, which might be accomplished by the aforementioned compacting. Opening compartments in this manner will provide that a symmetric arrangement of the circulating conveyor 5 will be achievable and that products will be straightened, and straightened at rapid rates, if necessary, after they have been inserted into compartments.

In the case of the example that has just been described, the circulating conveyor 5 employs a belt 15. Of course, a chain might also have been employed, in which case, each of the pair of drives 10 would have been equipped with a driven sprocket, backed up by a free-running, mating sprocket on the opposite side of the chain that will stabilize the chain. The drives 10 may be arranged at arbitrary locations along the circulating conveyor. Very long conveyors might be equipped with several drives.

1. A stacker for stacking products having
1.1 a closed-circuit, circulating, conveyor (5),
1.2 at least one drive (10) that acts on the conveyor (5) and drives it,
1.3 numerous compartments (3) that circulate with the conveyor (5),
1.4 a loading station (13) for inserting at least one product into each compartment (3),
1.5 an offloading station (14) for offloading stacks of products taken from several compartments (3), and
1.6 an opening for opening and closing the compartments (3) when they arrive at the loading station (13).

2. A stacker according to claim 1 having at least two independently operating drives (10) acting on the conveyor (5).

3. A stacker according to claim 1, wherein each compartment (3) has a pair of sidewalls (4) that are spread apart, relative to their normal positions relative to one another, at the opening station (13) and then brought back together after at least one product has been inserted between them.

4. A stacker according to claim 3, wherein the leading compartment wall (4), relative to the direction of motion of the conveyor (5), is moved.

5. A stacker to claim 3, wherein both compartment walls (4) are moved.

6. A stacker according to claim 3, wherein at least one compartment wall (4) is linearly translated.

7. A stacker according to claim 3, wherein at least one compartment wall (4) is rotated.

8. A stacker according to claim 3, wherein the compartment walls (4) are attached to a guide.

9. A stacker according to claim 3, wherein the compartment walls (4) are attached to the conveyor (5).

10. A stacker according to claim 3, wherein the guide for the compartment walls (4) and/or conveyor (5) has/have a bend where the opening station is located.

11. A stacker according to claim 1, wherein the conveyor (5) is guided over three rollers, pulleys, or sprockets (19, 20) situated where the opening station is located.

12. A stacker according to claim 1, wherein the routing of the conveyor (5) ahead of, and following, the opening station is symmetric.

13. A stacker according to claim 1 having at least two idler rollers, pulleys, or sprockets (6) for the conveyor (5) that form a pair of, preferably parallel, free runs (8, 9).

14. A stacker according to claim 1 whose conveyor (5) has several sections, each of which has parallel free runs (8, 9).

15. A stacker according to claim 14, wherein the sections are arranged such that they are angularly offset with respect to one another.

16. A stacker according to claim 1 having more than a single loading station (13).

17. A stacker according to claim 1 having more than a single offloading station (14).
